(19) United States
(12) Patent Application Publication
(10) Pub. No.: US 2021/0143621 A1
(43) Pub. Date: May 13, 2021

(54) TEMPLATE FOR ELECTRICAL BOX AND ELECTRICAL MOUNTING BRACKET

(71) Applicant: Kurt D. Kough, Vista, CA (US)

(72) Inventor: Kurt D. Kough, Vista, CA (US)

(21) Appl. No.: 16/680,138

(22) Filed: Nov. 11, 2019

(51) Int. Cl. H02G 3/12

(52) U.S. Cl. CPC H02G 3/123

(57) ABSTRACT

A template for installing an electrical box or an electrical mounting bracket. The template has a rectangular body with two long edges and two short edges. There is a see-through alignment slot positioned within the rectangular body. The alignment slot is parallel to either the two long edges or the two short edges. The template has at least two alignment indentations. The alignment indentations and the see-through alignment slot are in straight line alignment with each other. In one preferred embodiment, the template is used for the installation of a metal old work standard electrical box. In another preferred embodiment the template is used for the installation of a computer data low voltage mounting bracket.

The present invention relates to electrical boxes and electrical mounting brackets, and in particular, to templates for cutting out openings to install electrical boxes and electrical mounting brackets

### BACKGROUND OF THE INVENTION

Electrical boxes and electrical mounting brackets are well known in the prior art. FIG. 1 shows prior art metal old work standard electrical box 1 and FIG. 2 shows prior art low voltage electrical mounting bracket 2.

It is very common for an electrician or homeowner to install an electrical outlet or an outlet for computer data lines into a home. For example, to install an electrical box into a home, an electrician will cut out an installation opening into the drywall. The opening is cut to approximately the size of the electrical box so that a snug fit can be achieved. Different methods are typically used by the electrician to mark the area of the opening to cut. In one method the electrician will place the electrical box against the drywall and trace around it with a pencil. In another method the electrician will use a plastic template having a level to mark the area to make the cut. The prior art templates tend to be bulky, easy to break, cumbersome to use and expensive.

What is needed is a better template for electrical boxes and electrical mounting brackets.

### SUMMARY OF THE INVENTION

The present invention provides a template for installing an electrical box or an electrical mounting bracket. The template has a rectangular body with two long edges and two short edges. There is a see-through alignment slot positioned within the rectangular body. The alignment slot is parallel to either the two long edges or the two short edges. The template has at least two alignment indentations. The alignment indentations and the see-through alignment slot are in straight line alignment with each other. In one preferred embodiment, the template is used for the installation of a metal old work standard electrical box. In another preferred embodiment the template is used for the installation of a computer data low voltage mounting bracket. In another preferred embodiment the template may be used on a wall or on a ceiling. In another preferred embodiment the metal old work standard box template and the computer data low voltage bracket template may be used independently of one another or they may be used together, side-by-side and adjacent to one another.

### BRIEF DESCRIPTION OF THE. DRAWINGS

FIG. 1 shows a prior art electrical box.

FIG. 2 shows a prior art low voltage mounting bracket.

FIGS. 3 and 4 show a preferred embodiment of the present invention.

FIG. 5 shows another preferred embodiment of the present invention.

FIGS. 6-13 show a preferred method for utilizing the present invention.

FIG. 14 shows utilizing a template for horizontal installation.

FIGS. 15-16 show the utilization of another preferred embodiment of the present invention.

FIGS. 17-18 show the utilization of another preferred embodiment of the present invention.

FIGS. 19-20 show another preferred embodiment of the present invention.

### DETAILED DESCRIPTION OF THE PREFERRED EMBODIMENTS

FIG. 3 shows a preferred embodiment of the present invention. Template 5 has a length of approximately 3¼ inches, a width of approximately 2¼ inches, and a thickness of approximately 1/16 inch. In one preferred embodiment, template 5 has been punch cut out of a 1/16-inch-thick sheet of metal into the shape shown. In another preferred embodiment template 5 has been cut out of a 1/16-inch-thick sheet of metal using a metal sheet laser cutting machine.

Template 5 includes horizontal viewing slot 6 and vertical viewing slot 7. Horizontal slot 6 runs parallel to short edge 6 of template 5. Vertical slot 7 runs parallel to long edge 9 of template 5. Horizontal slot 6 and vertical slot 7 preferably intersect, as shown. Vertical triangular indentations 10 and 11 are positioned in line with vertical slot 7. Horizontal triangular indentations 12 and 13 are positioned in line with horizontal slot 6. Identifying language 14 states that the template is for a “Metal Old Work Standard Box”. Identifying symbol 15 shows that template 5 is the proper template for metal old work standard boxes. Electrical connectors are housed in metal old work standard boxes.

FIG. 4 shows a front view of template 5. Template 5 allows for alignment with either a vertical or horizontal line. For example, vertical slot 7 and triangular indentations 10 and 11 are in straight line alignment with each other. Therefore, when vertical slot 7 and vertical triangular indentations 10 and 11 are in alignment with vertical line 25, the user knows that template 5 is in proper alignment. Likewise, horizontal slot 6 and horizontal indentations 12 and 13 are in straight line alignment with each other. Therefore, when horizontal slot 6 and horizontal indentations 12 and 13 are in alignment with horizontal line 26, the user knows that template 5 is in proper alignment.

FIG. 5 shows another preferred embodiment of the present invention. Template 30 is for usage for cutting an installment opening for a low voltage bracket. Template 30 has a length of approximately 3 9/16 inches, a width of approximately 2⅛ inches, and a thickness of approximately 1/16 inch. In one preferred embodiment, template 30 has been punch cut out of a 1/16-inch-thick sheet of metal into the shape shown. In another preferred embodiment template 30 has been cut out of a 1/16-inch-thick sheet of metal using a metal sheet laser cutting machine. Identifying language 34 states that the template is for a “Computer—Data Low Voltage Bracket”. Identifying symbol 35 shows that template 30 is the proper template for computer—data low voltage brackets. Wiring for data lines for computers is housed in computer—data low voltage brackets.

Template 30 allows for alignment with either a vertical or horizontal line. For example, when vertical slot 37 and vertical triangular indentations 38 and 39 are in alignment with vertical line 40, the user knows that template 30 is in proper alignment. Likewise, when horizontal slot 46 and horizontal indentations 12 and 13 are in alignment with horizontal line 56, the user knows that template 30 is in proper alignment.

### Utilization of a Preferred Embodiment of the Present Invention

FIGS. 6-13 show a preferred method for using template 5.

In FIG. 6, the user has made a mark 61 on drywall 62. Mark 61 is where the user wishes to cut into the wall to install a metal old work standard box.

In FIG. 7, the user has drawn a longer horizontal line 61b over mark 62. Preferably the user has used a level to draw the horizontal line to ensure that the line is parallel to floor 63.

In FIG. 8, the user has placed template 5 over line 61b. FIG. 9 shows a close-up view of template 5 placed over line 61b. Horizontal slot 6 and horizontal indentations 12 and 13 are in alignment with horizontal line 61b, the user knows that template 5 is in proper alignment with short edge 8 parallel to floor 63.

In FIG. 10, the user has traced around template 5 using a pencil to draw rectangular shape 83.

In FIG. 11, the user has pulled template 5 away from the wall, leaving exposed traced rectangular shape 83.

In FIG. 12, using rectangular shape 83 as a guide, the user has used a hand saw to cut away a rectangular section of drywall to create opening 85.

In FIG. 13, the user has inserted metal old work standard electrical box 1 into opening 85 and has rigidly connected box 1 to the drywall. Metal old work standard electrical box 1 is now ready to receive an electrical outlet.

FIG. 14 shows another method of using template 5 for installing a metal old work standard box horizontally. In FIG. 14, template 5 has been orientated horizontally so that slot 7 and indentations 10 and 11 are in alignment with horizontal line 61b, the user knows that template 5 is in proper alignment with long edge 9 parallel to floor 63.

FIGS. 15 and 16 shows the utilization of template 30.

In FIG. 15, the user has placed template 30 over line 61b. Because horizontal slot 46 and horizontal indentations 47 and 48 are in alignment with horizontal line 61b, the user knows that template 30 is in proper alignment with short edge 88 parallel to floor 63.

In FIG. 16, template 30 has been orientated horizontally so that slot 37 and indentations 38 and 39 are in alignment with horizontal line 61b. Therefore, the user knows that template 30 is in proper alignment with long edge 89 parallel to floor 63.

FIGS. 17 and 18 show other preferred embodiments of the present invention. The embodiments shown in FIGS. 17 and 18 show it is possible to utilize a template that only includes one alignment slot and two triangular indentations that are aligned with the alignment slot.

In FIG. 17, the user has placed template 130 over line 61b. Because horizontal slot 146 and horizontal indentations 147 and 148 are in alignment with horizontal line 61b, the user knows that template 130 is in proper alignment with short edge 188 parallel to floor 63.

In FIG. 18, template 130b has been orientated horizontally so that slot 137 and indentations 138 and 139 are in alignment with horizontal line 61b. Therefore, the user knows that template 130 is in proper alignment with long edge 189 parallel to floor 63.

### Other Preferred Embodiment

FIGS. 19 and 20 show another preferred embodiment of the present invention. In FIGS. 19 and 20, templates 5b and 30b have been fabricated from ¼ inch thick plastic. Template 5b has a length of approximately 3¼ inches, a width of approximately 2¼ inches, and a thickness of approximately ¼ inch. Indentations 10b-13b extend into template 5b to a depth of approximately 1/16 inch. Vertical slot 7b has a length of approximately ¼ inch and a width of approximately 1/16 inch. Horizontal slot 6b has a length of approximately ¼ inch and a width of approximately 1/16 inch.

In FIG. 20, template 30b has a length of approximately 3 9/16 inches, a width of approximately 2⅛ inches, and a thickness of approximately ¼ inch. Indentations 38b, 39b, 47b and 48b extend into template 30b to a depth of approximately 1/16 inch. Vertical slot 37b has a length of approximately ¼ inch and a width of approximately 1/16 inch. Horizontal slot 46b has a length of approximately ¼ inch and a width of approximately 1/16 inch.

Although the above-preferred embodiments have been described with specificity, persons skilled in this art will recognize that many changes to the specific embodiments disclosed above could be made without departing from the spirit of the invention. For example, the above described template may be used on a wall or on a ceiling. Also, template 5 and template 30 may be used separately and independent of one another or they may be used side-by-side and adjacent to one another. Also, it should be noted that the above described templates can be made out of a variety of materials, including metal, plastic, composite materials, wood, and other materials as well. Therefore, the attached claims and their legal equivalents should determine the scope of the invention.

What is claimed is:

13) A template for an electrical box or an electrical mounting bracket installation, said template comprising:
D) a rectangular body, said rectangular body comprising two long edges and two short edges,
E) at least one see-through alignment slot positioned within said rectangular body, said alignment slot parallel to either said two long edges or said two short edges, and
F) at least two alignment indentations, wherein said at least two alignment indentations and said at least one see-through alignment slot are in straight line alignment with each other.

14) The template as in claim 1, wherein said at least one see-through alignment slot is two see-through alignment slots perpendicular to each other and intersecting each other, wherein said at least two alignment indentations is four alignment indentations, wherein a first pair of said four alignment indentations are in straight line alignment with one of said see-through alignment slots and wherein a second pair of said four alignment indentations are in straight line alignment with the other of said two see-through alignment slots.

15) The template as in claim 1, wherein said at least two alignment indentations are at least two triangular alignment indentations.

16) The template as in claim 1, wherein said at least two alignment indentations are positioned on the exterior of said rectangular body along said two long edges or along said two short edges.

17) The template as in claim 1, wherein said template is for a metal old work standard electrical box.

18) The template as in claim 1, wherein said template is for a computer data low voltage electrical mounting bracket.

19) A method for installing an electrical box or an electrical mounting bracket, said method comprising the steps of:
G) drawing an alignment line on a wall,
H) acquiring a template, said template comprising:
iv. a rectangular body, said rectangular body comprising two long edges and two short edges,
v. at least one see-through alignment slot positioned within said rectangular body, said alignment slot parallel to either said two long edges or said two short edges, and
vi. at least two alignment indentations, wherein said at least two alignment indentations and said at least one see-through alignment slot are in straight line alignment with each other
I) aligning said at least one see-through alignment slot and said at least two alignment indentations with said alignment line,
J) tracing said template to create a traced rectangle,
K) cutting out said traced rectangle to form an installation opening in said wall, and
L) installing said electrical box or said electrical mounting bracket in said installation opening.

20) The method as in claim 7, wherein said at least one see-through alignment slot is two see-through alignment slots perpendicular to each other and intersecting each other, wherein said at least two alignment indentations is four alignment indentations, wherein a first pair of said four alignment indentations are in straight line alignment with one of said see-through alignment slots and wherein a second pair of said four alignment indentations are in straight line alignment with the other of said two see-through alignment slots.

21) The method as in claim 7, wherein said at least two alignment indentations are at least two triangular alignment indentations.

22) The method as in claim 7, wherein said at least two alignment indentations are positioned on the exterior of said rectangular body along said two long edges or along said two short edges.

23) The method as in claim 7, wherein said template is for a metal old work standard electrical box.

24) The method as in claim 7, wherein said template is for a computer data low voltage electrical mounting bracket.
